(19) United States
(12) Patent Application Publication
(10) Pub. No.: US 2006/0112631 A1
(43) Pub. Date: Jun. 1, 2006

(54) Transport container for plant cuttings

(75) Inventor: Cornelis Wilhelmus Dekker, Hensbroek (NL)

Correspondence Address: DARBY & DARBY P.C., P. O. BOX 5257, NEW YORK, NY, 10150-5257, US

(73) Assignee: Dekker Chrysanten B.V., Hensbroek (NL)

(21) Appl. No.: 11/260,468

(22) Filed: Oct. 26, 2005

(30) Foreign Application Priority Data
Oct. 28, 2004 (NL) 1027361

(51) Int. Cl. A01G 9/02

(52) U.S. Cl. 47/65.5

(57) ABSTRACT

The invention relates to a transport container for the transport of plant cuttings having a bottom and upright side walls into which cutting receptacles with cuttings can be placed, wherein the side walls have a height such that their top edge extends beyond the top ends of the cuttings, wherein the container is provided with a lid that can be closed, wherein the container is manufactured from a shape-retentive, moisture-proof and moisture-impervious material.

### CROSS REFERENCE TO RELATED APPLICATION

This application claims the benefit of Dutch Patent Application No. 1027361 filed Oct. 28, 2004 which is incorporated by reference herein.

### FIELD OF THE INVENTION

The invention relates to a container for the transport of plant cuttings.

### BACKGROUND

A standard method for propagating particular plants is to raise plants for cuttings, to subsequently root these cuttings and then to plant the rooted cuttings in a growth medium and to allow them to grow into a plant.

The location where plant cuttings are produced is often not the same as where the cuttings are rooted. For example, chrysanthemum cuttings are obtained from plants grown in African and South American countries, whereafter the cuttings are transported by air to the Netherlands, where the cuttings are rooted.

According to common practice, these cuttings are put into cutting receptacles that are connected to each other to form strips of a particular length. These strips are then placed next to each other into cardboard boxes. In these boxes the cuttings are then transported, mainly by air, to the location where rooting will take place. Here the cutting receptacles with the cuttings are taken out of the boxes and the cardboard boxes are taken away as waste. The drawback is that the boxes are suitable to be used only once so that apart from the costs for purchase and disposal, this also places a burden on the environment. In addition, in some circumstances the cardboard boxes absorb moisture, causing them to lose their rigidity and as a result their shape. This may have numerous undesirable consequences such as direct damage to the cuttings, or tears in the box, which impairs the insulation, which in turn may be detrimental for the cuttings. The absorption of moisture in the boxes may also lead to fungal growth, possibly infecting the cuttings with diseases. Moreover, the cuttings have to be wrapped in plastic to avoid dehydration.

### SUMMARY OF THE INVENTION

It is an object of the invention to provide a transport container for plant cuttings that can be reused several times and that retains its protective properties with regard to the cuttings.

According to the invention, this objective is achieved with a transport container according to claim 1. When a container is manufactured from a shape-retentive, moisture-proof and moisture-impervious material, the container will even after use retain its shape and usability and is suitable to be reused. Also, fungal growth is not encouraged because the container does not absorb moisture, which has a positive effect on the occurrence of diseases. Moreover, as the container is moisture-impervious it is no longer necessary to wrap the cuttings in plastic.

In a favourable embodiment of the transport container, the bottom, the lid and the upright side walls are composed of a frame with a plate fastened thereto. In this way a strong but light construction can be realised, largely because the frame provides the constructional strength, allowing the plates to be embodied very lightly. This not only improves the ease of handling but it is also especially advantageous with a view to the transport by air.

Both for the frame and the plates plastic is a suitable material that meets the requirements. Moreover, it can be produced at a favourable cost, especially in large numbers. However, it is also possible to use a different moisture-resistant material for the frame, e.g. a moisture-proof metal.

A good combination of light weight and good strength can be achieved if the plate has a cellular structure, while this may also considerably improve the thermal insulation properties. This is especially important for the cuttings, too much fluctuation in temperature must be avoided. In addition, the cellular structure improves the strength and with that also the other protective properties of the container.

To further improve the robustness of the container, it may be embodied such that the edges of the lid are at least partly provided with a groove, into which the respective portion of the raised edge fits tightly. When the lid is placed upon such a container, it contributes considerably to the rigidity of the entire container. The same effect can, of course, be achieved when the groove is provided in the walls and the lid is provided with a tightly fitting projection.

In an advantageous embodiment, the top side of the lid of the transport container, near to the circumference, is provided with a raised edge for receiving the bottom side of another transport container. This allows the container to be stacked in a secure manner. This could be especially important for the automatic handling of the containers.

The lid can be fastened on the upright side walls with enhanced reliability by providing the lid and at least one of the upright walls with locking means to lock the lid to the upright side walls.

When filling the containers with cuttings and when taking them out again, it is convenient for the lid to be removable. This can simplify the process considerably.

During transport, the cuttings develop particular gases. By providing at least either the lid, the bottom or the walls, or a combination of these with openings of an adequate size to allow vapour and gas to pass through while being impermeable to drops of liquid, those gases can be discharged and fresh air can enter, without drops of liquid being able to penetrate into or escape from the container.

Regarding the return transport it is advantageous for the upright side walls and the bottom to form an angle of more than 90°. This makes the containers nestable and saves a considerable amount of space on the return transport, which has a particularly favourable effect on the costs of this transport.

Especially with regard to automatic handling of the container, for example before or at filling machines, it may be auspicious to nest the containers such that their bottoms are not completely or almost in contact with each other, but to leave some space between them. This may be achieved by providing projections at a particular height of the upright walls, having flat undersides, and projecting beyond the vertical plane to at least beyond the top rim. Although some of the space that was saved is thus given up again, it greatly facilitates unloading of the containers.

With large containers, advantages are gained when the interior of the transport container is provided with at least one vertical partition. This divides the space in the container into compartments, guaranteeing a safer and more reliable transport of the cutting receptacles with the cuttings. With respect to nesting during the return transport it is advantageous when the partition(s) can be folded down and/or removed. This also creates sufficient space for returning the empty strips of cutting receptacles in the containers.

### BRIEF DESCRIPTION OF THE FIGURES

The invention will now be further elucidated by way of the following description of a preferred embodiment of the invention, with reference to the drawing in which:

FIG. 1 shows a schematic illustration in perspective of a transport container according to an embodiment of the invention,

FIG. 2 shows a top view of a frame of the tray of a transport container according to an embodiment of the invention,

FIG. 3 shows a cross section of a plate having a cellular structure in accordance with an embodiment of the invention,

FIG. 4 shows a detail of how the lid locks to one of the side-walls according to an embodiment of the invention,

FIG. 5 shows two stacked containers according to an embodiment of the invention,

FIG. 6 shows an example of a locking mechanism between the lid and a side-wall of a container according to an embodiment of the invention,

FIG. 7 shows a hinging and removable mechanism for fastening a partition to the bottom.

### DETAILED DESCRIPTION

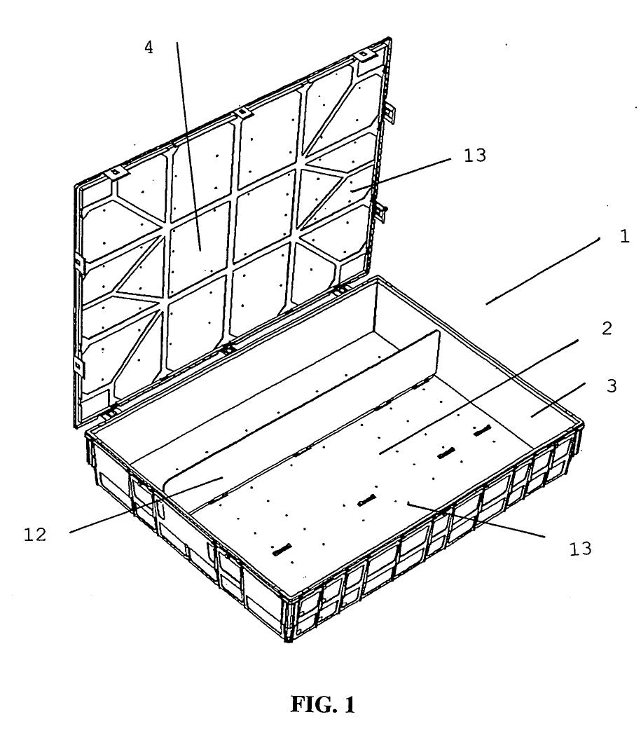

FIG. 1 shows a schematic illustration in perspective of a transport container, generally designated with 1, which according to an embodiment of the invention is provided with a bottom 2, side walls 3 and a separate lid 4. In this embodiment, the entire container is made of a shape-retentive moisture-resistant and moisture-impervious plastic. The bottom, the lid, as well as all the side-walls are each composed of a frame 5 to which a plastic plate is fastened.

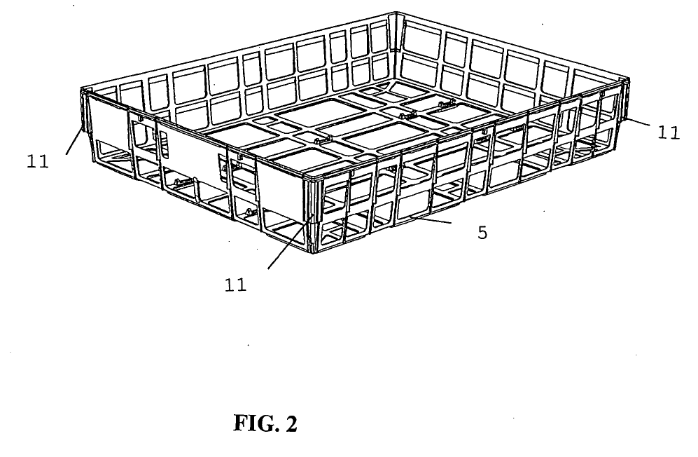

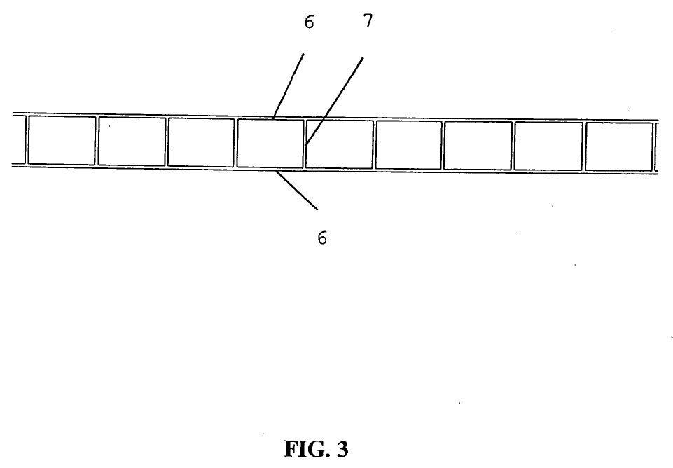

The frame of the tray of the container is shown in FIG. 2 as a perspective elevation. To the frame, a plastic plate having a cellular structure is fastened. In this embodiment, the plate is composed of two equidistant thin plates 6, which are interconnected at regular intervals by connecting partitions 7, as shown in cross section in FIG. 3. This allows the construction of the plates to be very lightweight while still being fairly strong. In such a composition the frame also fulfils the requirements with respect to strength. Everything together makes it possible for the construction to be especially light and yet robust. Moreover, the cellular structure in the plates provides the container with excellent thermal insulation properties.

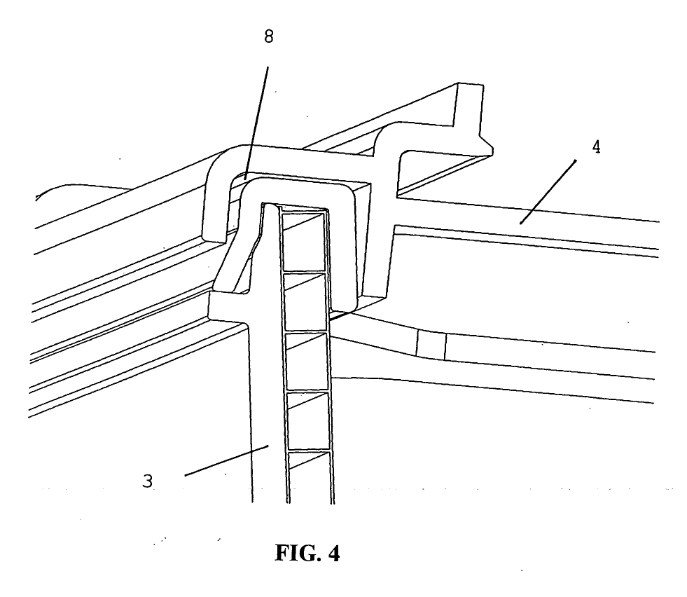

The embodiment of the invention described has a lid 4, provided along the whole edge with a groove 8 into which the top edges of the side walls 3 fit tightly, as can be seen in FIG. 4. Apart from closing the container off to be effectively moisture-proof, this also contributes greatly to the rigidity, and consequently the shape retention of the container.

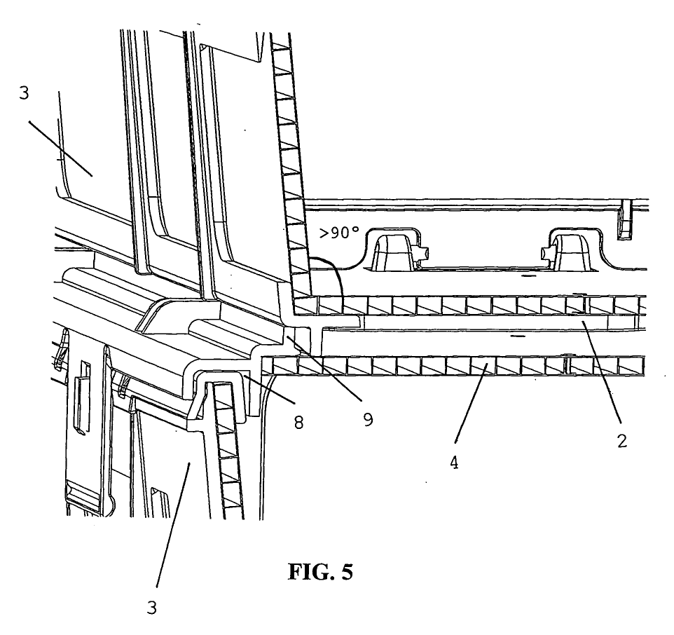

FIG. 5 shows two stacked containers wherein the lid is provided with a raised edge 9 such that it defines a rectangle into which the container stacked on top fits. The edge 9 prevents said container from moving with respect to the lower container. This is particularly advantageous because it allows stacks of containers to be handled and transported by automatic handling equipment.

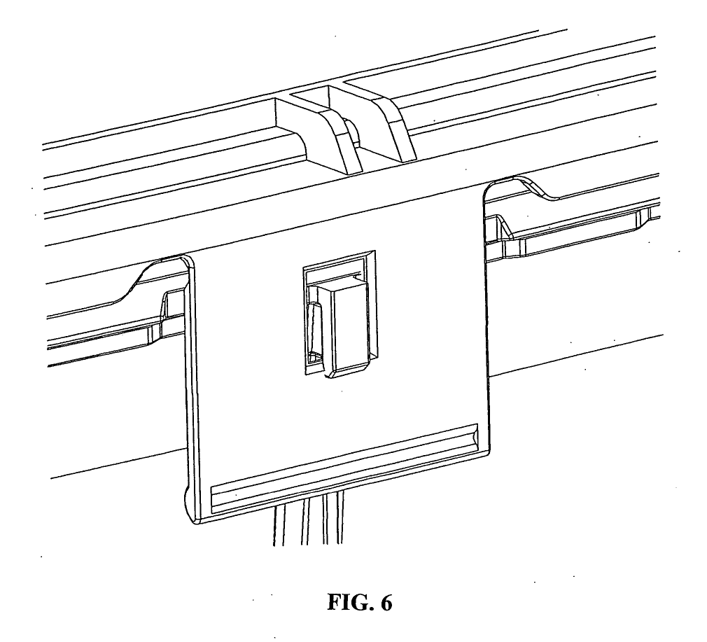

To allow the lid 4 to be firmly fastened to the side-walls 3, each rim of the lid is provided with at least one lip 10 having an opening, which snaps into a complementary projection at the side-wall 3 to form a lock, as can be seen in FIG. 6.

FIG. 5 also shows that the upright walls and the bottom form an angle that is slightly larger than 90°. This allows the containers on the return transport to be stacked, nested so that the empty containers take up considerably less space. To this end the lids are removed. These are stacked separately and transported.

In order to facilitate unloading of nested containers, the outsides of side-walls 3 are provided with projections 11 that project in such a manner that when nesting, the container rests with said projections 11 on the upper edge of a lower container. These projections 11 are illustrated in FIG. 2. The projections 11 are positioned such that the sidewalls and the bottoms of stacked containers are not in contact with each other and that the containers are thus unable to adhere to each other through suction, which could cause considerable inconvenience in the mechanised process. The space created between the bottoms of the nested containers suffices for returning the empty strips of cutting receptacles.

For additional protection of the cuttings to be transported, the bottom 2 of the container is provided with partitions 12. One partition 12 is shown in FIG. 1. FIG. 1 also illustrates that the bottom as well as the lid is provided with regularly spaced small openings 13. These openings allow gas and vapour to pass through but are so small that drops of moisture are unable to pass through. In this way the container can be ventilated in a natural manner without losing the moisture-non-permeable properties.

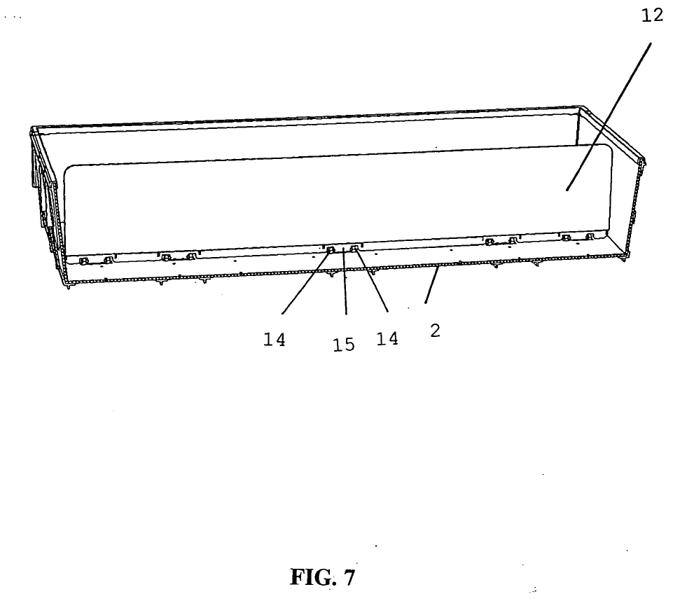

At their bottom sides, the partitions 12 in this embodiment of the invention are at regular intervals provided with projections 15, which form a snap connection with pairs of projections 14 on the bottom 2, see FIG. 7. The projections 14 and 15 form hinges allowing the partitions, when in use, to be folded up and during the return transport to be folded down or possibly removed. In this upright condition, the partitions 12 are locked to the side walls so that they will remain upright even when subjected to some pressure exerted by the strips with cutting receptacles and cuttings contained therein.

What is claimed is:

1. A transport container (1) for the transport of plant cuttings having a bottom (2) and upright side walls (3) into which cutting receptacles with cuttings can be placed, wherein the side walls (3) have a height such that their top edge extends beyond the top ends of the cuttings, wherein the container (1) is provided with a lid (4) that can be closed, wherein container (1) is manufactured from a shape-retentive, moisture-proof and moisture-impervious material.

2. A transport container (1) according to claim 1, wherein at least one of the bottom (2), the lid (4) and the upright side walls (3) are composed of a frame (5) with a plate fastened thereto.

3. A transport container (1) according to claim 2, wherein the plate is a plastic plate.

4. A transport container (1) according to claim 2, wherein the plate has a cellular structure.

5. A transport container (1) according to claim 2, wherein the frame (5) is made of plastic.

6. A transport container (1) according to claim 2, wherein the frame (5) is made of metal.

7. A transport container (1) according to claim 1, wherein the edges of the lid (4) are at least partly provided with a groove (8) to interlock tightly with at least a portion of the upright wall (3).

8. A transport container (1) according to claim 1, wherein the lid (4) and at least one of the side walls (3) are provided with locking means (10) to lock the lid to the side walls (3).

9. A transport container (1) according to claim 1, wherein the top side of the lid, near to the circumference, is provided with a raised edge (9) for receiving the bottom side of another transport container (1).

10. A transport container (1) according to claim 1, wherein the lid (4) is removable.

11. A transport container (1) according to claim 1, wherein at least one of the lid (4), the bottom (2) and the walls (3) are provided with openings (13) of an adequate size to allow vapour and gas to pass through while being impervious to drops of liquid.

12. A transport container (1) according to claim 10, wherein the side walls (3) and the bottom (2) form an angle of more than 90°.

13. A transport container (1) according to claim 12, wherein at a particular height the side walls (3) are provided with projections (11) having flat undersides, and projecting in the vertical plane to at least beyond the inside of the top rim.

14. A transport container (1) according to claim 1, wherein the interior of the transport container (1) is provided with at least one vertical partition (12).

15. A transport container (1) according to claim 14, wherein at least one vertical partition (12) is fastened to the bottom (2) in a manner to allow folding down.

16. A transport container (1) according to claim 14, wherein at least one vertical partition (12) is removably fastened to the bottom (2).
